(19) United States
(12) Patent Application Publication
(10) Pub. No.: US 2018/0277862 A1
(43) Pub. Date: Sep. 27, 2018

(54) EXHAUST PROCESSING UNIT

(71) Applicant: INTELLIGENT ENERGY LIMITED, Loughborough (GB)

(72) Inventor: Scott Baird, Loughborough (GB)

(73) Assignee: INTELLIGENT ENERGY LIMITED, Loughborough (GB)

(21) Appl. No.: 15/543,203

(22) PCT Filed: Jan. 8, 2016
(86) PCT No.: PCT/GB2016/050050

§ 371 Date: Jul. 12, 2017

(30) Foreign Application Priority Data
Jan. 12, 2015 (GB) 1500439.3

(51) Int. Cl. H01M 8/04089; H01M 8/04746; H01M 8/2457; H01M 8/04537; H01M 8/04223; H01M 8/04858

(52) U.S. Cl. CPC H01M 8/04097; H01M 8/04753; H01M 8/04761; H01M 8/04902; H01M 8/04619; H01M 8/04231; H01M 8/2457

(57) ABSTRACT

A fuel cell exhaust processing unit for consuming fuel in the exhaust flow of a main fuel cell module comprising a fuel cell assembly configured to receive the exhaust flow from an anode flow path of the main fuel cell module, the fuel cell assembly electrically connected and configured to consume fuel remaining in the exhaust flow from the main fuel cell module to a predetermined level before the exhaust flow exits the unit.

This invention relates to an exhaust processing unit for processing the exhaust of a main fuel cell module. In particular, it relates to a unit for consuming any hydrogen in the exhaust of a main fuel cell module.

Conventional electrochemical fuel cells convert fuel and oxidant, generally both in the form of gaseous streams, into electrical energy and a reaction product. A common type of electrochemical fuel cell for reacting hydrogen and oxygen comprises a polymeric ion (proton) exchange membrane (PEM), with fuel and air being passed over respective sides of the membrane. Thus, the fuel flows along an anode flow path over the membrane (and any gas diffusion structures) and the oxidant flows along a cathode flow path and over the other side of the membrane (and any gas diffusion structures). Protons (that is, hydrogen ions) are conducted through the PEM, balanced by electrons conducted through a circuit connecting the anode and cathode of the fuel cell. To increase the available voltage, a stack may be formed comprising a number of such membranes arranged with separate anode and cathode fluid flow paths. Such a stack is typically in the form of a block comprising numerous individual fuel cell plates held together by end plates at either end of the stack. An anode inlet manifold typically delivers fuel (e.g. hydrogen) to the anode flow paths and an anode outlet manifold receives the exhaust from the anode flow paths. Likewise, a cathode inlet manifold typically delivers oxidant to the cathode flow paths and a cathode outlet manifold receives the exhaust from the anode flow paths. The anode exhaust may contain unused fuel, such as hydrogen. It is preferable to avoid the release of hydrogen into the atmosphere.

According to a first aspect of the invention we provide a fuel cell exhaust processing unit for consuming fuel in the exhaust flow of a main fuel cell module comprising;
a fuel cell assembly configured to receive the exhaust flow from an anode flow path of the main fuel cell module, the fuel cell assembly electrically connected and configured to consume fuel remaining in the exhaust flow from the main fuel cell module to a predetermined level before the exhaust flow exits the unit.

This is advantageous as any fuel present in the exhaust or purge gases can be consumed, in a dedicated exhaust processing unit, and may thereby reduce the fuel released to the atmosphere. Further, the fuel cell assembly can be electrically controlled such that it effectively consumes the hydrogen. The main fuel cell may be controlled to provide power for a load while the fuel cell exhaust processing unit may be configured or controlled to optimize the consumption of fuel. Configuring the fuel cell assembly such that the fuel content of the exhaust is consumed to a predetermined level (such as substantially free of fuel) as it flows through the assembly provides an effective way of processing the fuel cell exhaust flow. The exhaust flow may comprise a purge gas used to drive reaction by-products and contaminants from the main fuel cell. The purge gas may comprise the fuel used by the main cell, such as hydrogen.

The fuel cell assembly may comprise a plurality of individual fuel cells arranged in gas flow series in the anode flow path. Accordingly, the anode gas flow passes through each of the plurality of fuel cells in turn.

The plurality of fuel cells may be electrically unconnected to each other. Thus, while arranged in gas flow series they may not be in electrical series. It is advantageous to electrically operate each of the plurality of the fuel cells individually. This enables the unit to react to the concentration of fuel present in each of the fuel cells in the fuel cell assembly to consume unused fuel or purge gas.

The fuel cell assembly may include a controller to control the flow of current between an anode and a cathode of at least one of the fuel cells in the fuel cell assembly for consuming remaining hydrogen in the exhaust flow. Thus, the anode and cathode of the or each fuel cell may be connected together via the controller. The controller can therefore control the flow of current between the anode and cathode of the fuel cell. Thus, if a voltage is detected between the anode and cathode, indicating the presence of hydrogen in the fuel cell, the controller may permit the current to flow to consume the hydrogen. Each fuel cell in the assembly may include a controller or a common controller may control the or each fuel cell. Optionally, the controller comprises a passive controller having a predetermined resistance. The passive controller thus provides a current path between the anode and cathode of the fuel cell enabling it to consume fuel when present. Thus, the passive controller may comprise an electrical conductor wire or track.

The controller may be configured to control the flow of current of the at least one fuel cell in response to a measure of the electrical output of at least one of the fuel cells of the fuel cell assembly. Thus, the voltage across one or more of the fuel cells may be used to control the current that flows between the anode and cathode of one or more of the fuel cells. The voltage across a given fuel cell may be used to control the current flow across said fuel cell or a different fuel cell in the assembly.

The fuel cell assembly may comprise at least two fuel cells and the controller is configured to control the flow of current between the anode and cathode of a first fuel cell in response to a measure of the electrical output of at least one of the fuel cells of the fuel cell assembly located upstream of the first fuel cell.

The fuel cell exhaust processing unit may include a purge valve arranged downstream of the fuel cell assembly of the fuel cell exhaust processing unit, the purge valve configured to control the emission of the exhaust flow from the processing unit. The purge valve may therefore control the release of gases, such as to atmosphere, which have passed through the fuel cell assembly of the fuel cell exhaust processing unit. In other examples, the purge valve is replaced with a restriction to control the flow rate out of the anode flow path through the unit.

The purge valve may be actuated by a purge valve controller, the purge valve controller configured to actuate the purge valve in response to a measure of the electrical output of at least one of the fuel cells of the fuel cell assembly. The presence of hydrogen in the exhaust gases may be detected as a voltage across one or more of the fuel cells. Accordingly, the electrical output may be used to determine when the purge valve can be opened.

The purge valve may actuated by a purge valve controller, the purge valve controller configured to actuate the purge valve based on receipt of a purge signal indicative of a purge operation comprising the flow of a purge gas through the anode flow path of the main fuel cell assembly. Thus, the purge valve controller may determine when to open the purge valve based on a time period since the initiation of a purge operation. Accordingly, the time taken for the fuel cell assembly to consume the hydrogen used for a purge operation may be estimated and used to control the purge valve.

The purge valve may be actuated by a purge valve controller, the purge valve controller configured to actuate the purge valve based on a measure of the pressure of the exhaust flow. Accordingly a pressure sensor may be present in the unit.

The fuel cell assembly may be arranged in an exhaust pipe for processing the exhaust flow as it travels along said exhaust pipe. The exhaust pipe or conduit may be divided into an anode flow path and a cathode flow path, with the fuel cell assembly arranged between the anode and cathode flow paths with the anode and cathode sides lying in said corresponding flow path.

According to a second aspect of the invention we provide a combination of a main fuel cell module and a fuel cell exhaust processing unit as defined in the first aspect, said main fuel cell module including an anode flow path therethrough, the processing unit connected in gas flow series with the main fuel cell module to receive the exhaust flow.

The fuel cell assembly may be electrically unconnected to the main fuel cell module.

According to a third aspect of the invention we provide a method of processing an exhaust flow from a main fuel cell module comprising;
applying the exhaust flow to a fuel cell assembly;
controlling the fuel cell assembly to consume any fuel present in the exhaust flow to produce a processed exhaust flow; and optionally
releasing said processed exhaust flow from the assembly.

The method may comprise electrically controlling the fuel cell assembly to effectively consume fuel.

The method may include the step of controlling a purge valve, which releases exhaust flow from the fuel cell assembly, based on the electrical output of the fuel cell assembly. The exhaust flow may be retained in the fuel cell assembly until any fuel in the exhaust flow is consumed to a predetermined level. The processed exhaust may be released to atmosphere. Thus, control of the purge valve of the fuel cell assembly provides time for fuel to be consumed in the fuel cell assembly. A combination of control of the purge valve and electrical control of the fuel cell assembly may be employed.

According to a fourth aspect of the invention we provide a vehicle powered by a main fuel cell and including the fuel cell exhaust processing unit of the first aspect of the invention.

The vehicle may comprise a car, bus, coach, motorbike, airplane, ship or any other form of vehicular transport.

We also disclose a fuel cell exhaust processing unit for consuming fuel in an exhaust flow whether or not the exhaust flow is from a main fuel cell module comprising a fuel cell assembly configured to receive the exhaust flow, the fuel cell assembly electrically connected and configured to consume fuel remaining in the exhaust flow from the main fuel cell module to a predetermined level before the exhaust flow exits the unit.

There now follows, by way of example only, a detailed description of embodiments of the invention with reference to the following figures, in which:

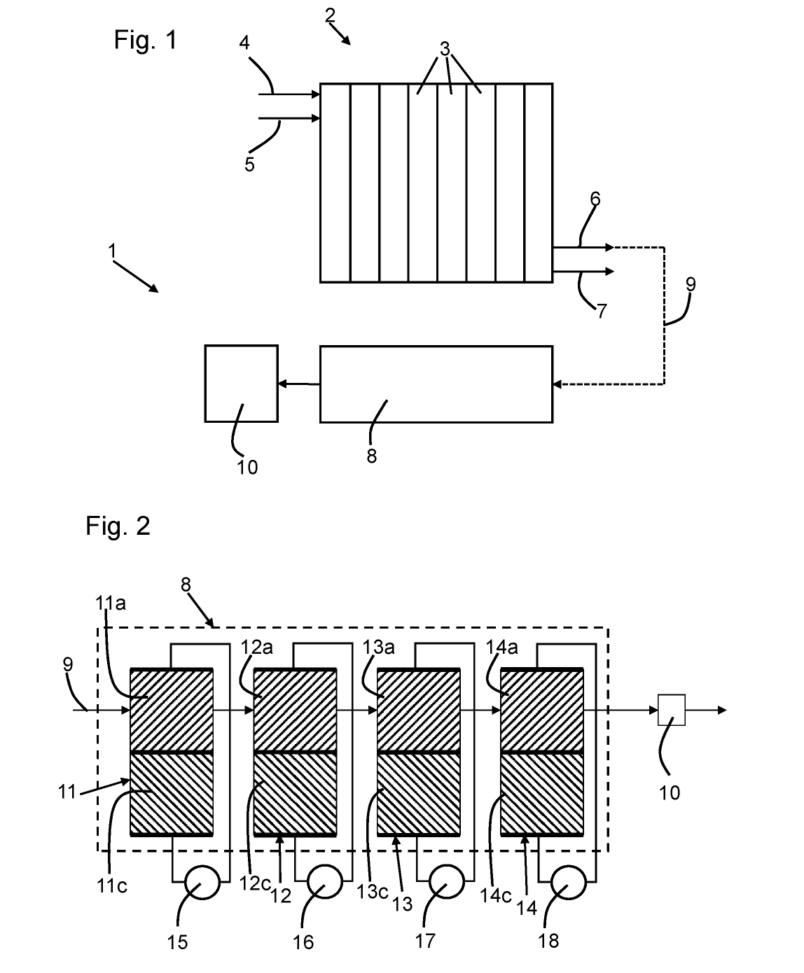

FIG. 1 shows a schematic diagram of a first example of a fuel cell exhaust processing unit;

FIG. 2 shows a schematic diagram of an example fuel cell assembly and purge valve of the unit of FIG. 1;

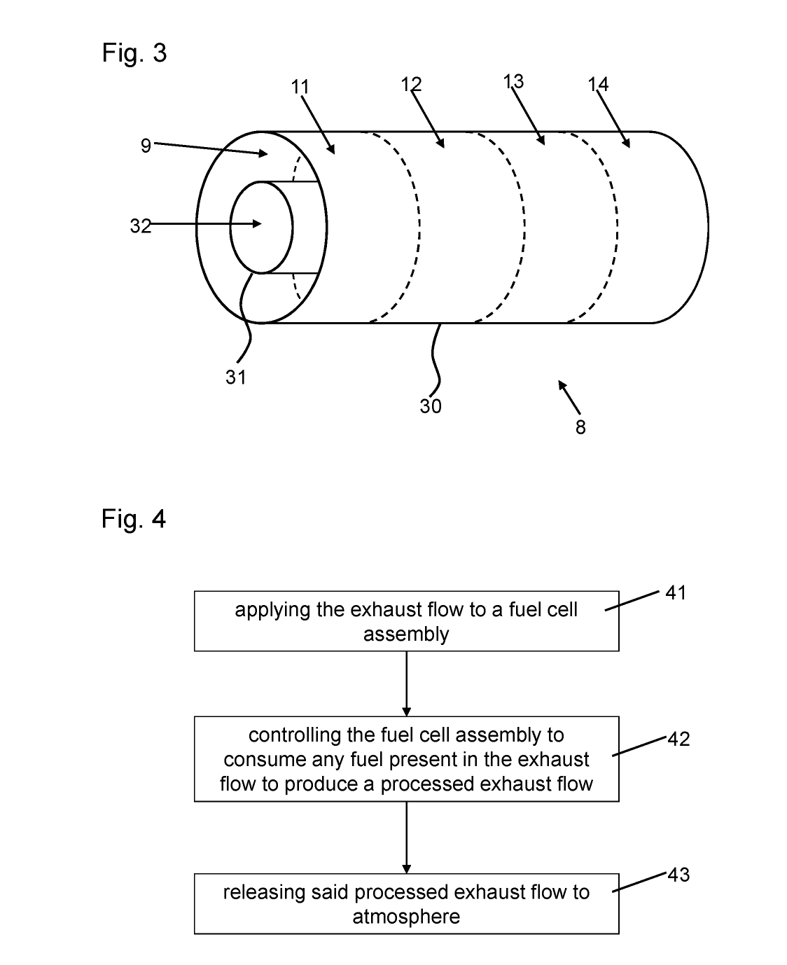

FIG. 3 shows a second example of a fuel cell assembly; and

FIG. 4 shows a flow chart illustrating a method of processing an exhaust flow from a fuel cell.

A main fuel cell module consumes hydrogen during operation to generate power for a load but some hydrogen may remain, unused, in the exhaust flow. Further, a main fuel cell module may be configured such that its flow paths are purged, as required or periodically, with a purge gas to remove moisture and/or contaminants and/or diluents that accumulate in use. It is common for the purge gas in an anode flow path of a fuel cell module to comprise the fuel, such as hydrogen. Accordingly, the exhaust flow from the anode flow path through the main fuel cell module may contain the hydrogen purge gas. The purge operation may comprise passing fuel through the anode flow path of the main fuel cell module at a greater rate than during normal operation and/or when the main fuel cell module is turned off.

FIG. 1 shows a fuel cell exhaust processing unit 1 for consuming fuel in the exhaust flow of a main fuel cell module 2. Accordingly, the fuel cell exhaust processing unit 1 is configured to be arranged in gas flow series with the main fuel cell module 2. The main fuel cell module 2, in this example, comprises a fuel cell stack of a plurality of fuel cells 3 arranged in gas flow parallel. In other examples the fuel cell module may comprise a single cell or a plurality of fuel cells arranged in a configuration other than a stack.

The stack 2 and fuel cell exhaust processing unit 1, when in use, are arranged in an anode flow path. The anode flow path includes an anode inlet 4 for introducing fuel, such as hydrogen, into the stack. The stack also includes a cathode inlet 5 for introducing an oxidant, such as air, into the stack. The anode and cathode inlets 4, 5 connect to respective inlet manifolds (not shown) that deliver the fuel and oxidant to each of the fuel cells 3 in the stack 2. The anode and cathode flow paths may further include corresponding outlet manifolds to receive the fuel and oxidant from the fuel cells and provide the anode exhaust to an anode exhaust outlet 6 and the cathode exhaust to a cathode exhaust outlet 7. The exhaust flow may thus comprises the reactants that may have passed through the main fuel cell stack 2, any reaction by-products that may have been generated by the stack and any purge gas that may have been applied to the anode flow path during a purge operation. The anode flow path continues from the outlet 6 to the fuel cell exhaust processing unit 1.

A fuel cell assembly 8 of the fuel cell exhaust processing unit 1 comprises at least one fuel cell and is configured to receive, by way of a conduit 9, the exhaust flow from the anode flow path of the main fuel cell module 2. The fuel cell assembly 8 is electrically connected to consume fuel remaining in the exhaust flow from the main fuel cell module 2. Thus, rather than being configured to power a load, the fuel cell assembly 8 is electrically connected to consume hydrogen in the anode exhaust flow. The main fuel cell module may be controlled such that anode and/or cathode fluid flows/pressures are provided/modulated/controlled to maintain a voltage and a useful or predetermined power output. The exhaust processing unit is controlled to remove fuel and as such the anode flows/pressures may be un-controlled and the power output (current) flow may be controlled to reduce the voltage which is equivalent to consuming fuel. Thus, in general, the fuel cell assembly of the exhaust processing unit is controlled to reduce the voltage across the fuel cell assembly to a greater degree, on average, than the main fuel cell module. Put another way, the main fuel cell module may be controlled to maintain an operating voltage to a greater degree than the fuel cell assembly of the fuel cell exhaust processing unit. The electrical connection of the fuel cell assembly 8 may be such that the consumption of hydrogen is optimised based on predetermined criteria or feedback from measured parameters. In one example, one or more of the fuel cells in the fuel cell assembly 8 may have its anode and cathode directly electrically connected together, although other electrical connections are considered. The voltage across the fuel cell assembly 8 may be controlled by controlling the connection between the anode and cathode of the fuel cell assembly 8 such that the voltage falls below a predetermined voltage. This may be indicative of a fuel concentration in the exhaust flow reaching an acceptable limit. Alternatively, the fuel concentration may be measured directly by a sensor and the voltage across the fuel cell assembly 8 controlled in response thereto.

The fuel cell exhaust processing unit 1 includes a purge valve 10 for controlling the release of the exhaust gases from the fuel cell assembly 3 to, in this example, atmosphere. Thus, with the purge valve 10 closed the exhaust gas pressure in fuel cell assembly 8 may be elevated as purge gas and/or exhaust gas is received from the main fuel cell module 2. The purge valve 10 may be opened when the hydrogen concentration in the fuel cell assembly 8 is below a predetermined threshold.

FIG. 2 shows a further and more detailed example of the fuel cell exhaust processing unit 1. The fuel cell assembly 8 comprises a plurality of individual fuel cells 11, 12, 13, 14. In this example, four fuel cells are provided but other numbers of fuel cells are envisaged. Each fuel cell 11, 12, 13, 14 includes an anode side 11a, 12a, 13a and 14a and a cathode side 11c, 12c, 13c, 14c. The fuel cells may comprise PEM fuel cells and the anode and cathode sides thus comprise gas diffusion structures either side of a membrane forming a membrane electrode assembly. The anode side of a first of the fuel cells 11 is electrically connected to its cathode side. Likewise, the anode side of each of the other fuel cells is electrically connected to its corresponding cathode side. At least two (and preferably the majority) of the fuel cells of the fuel cell assembly may be electrically unconnected to one another and in this example, all of the fuel cells are electrically unconnected to one another. In another example, all of the fuel cells may be electrically connected together. Thus, the fuel cells of the assembly 8 may be operated electrically independently of one another to consume hydrogen. In this example, all of the fuel cells are electrically unconnected to the main fuel cell module 2. The fuel cells are arranged in gas flow series and therefore the first fuel cell 11 can be considered to upstream of the second, third and fourth fuel cells 12, 13, 14. Similarly, the final fuel cell 14 is downstream of the other fuel cells 11, 12, 13.

The fuel cell assembly 8 may include an inlet valve upstream in the anode flow path of the first fuel cell 11. The inlet valve may be used to control the pressure in the fuel cell assembly 8.

Each of the fuel cells 11, 12, 13, 14 of the fuel cell assembly are arranged in gas flow series in the anode flow path. Thus, a first fuel cell 11 of the assembly 8 receives the exhaust from the main fuel cell module 2 and each other fuel cell 12, 13, 14 of the assembly receives the exhaust flow from a preceding fuel cell of the assembly 8. The anode exhaust of the main fuel cell 2 thus passes through the anode side of each fuel cell of the assembly 8 in turn. The flow from the final fuel cell 14 and therefore through the assembly 8 is controlled by the purge valve 10.

Each fuel cell 11, 12, 13, 14 of the assembly 8 may include a respective controller 15, 16, 17, 18. In another embodiment, the fuel cells 11, 12, 13, 14 of the assembly 8 are electrically operated individually by a common controller. The controllers may be configured to draw a specific current or current profile from its associated cell or actively alter their resistance to draw a specific current or current profile. Thus, the controllers may be passive and comprise a fixed resistance (e.g. a wire connection or discrete resistance) or they may be active and comprise a controllable resistance. For example, the anodes 11a, 12a, 13a, 14a may be connected directly to their associated cathode 11c, 12c, 13c, 14c via a resistance or electrical wire/conductor, which may be considered passive controllers of current flow.

The operation of the exhaust processing unit 1 will be now be described with reference to a purge operation of the main fuel cell module 2. It will be appreciated that the unit 1 may be used to consume hydrogen in other situations such as during normal use of the main fuel cell module. Initially the purge valve is closed. The gas mixture in the fuel cell assembly 8 may contain no hydrogen (as it may have been consumed in a previous cycle) and may be at an ambient pressure or less. When a purge operation is performed, hydrogen purge gas is driven, by a pressure differential and/or pump, through the anode flow path and thus through the fuel cell stack 2 and into the fuel cell assembly 8. The purge gas enters the fuel cell assembly 8 and the first cell 11 first, then the second cell 12 and so on. This will compress the gas already present in the fuel cell assembly 8. Thus, for example, the first and second fuel cells 11, 12 (termed here the upstream cells) may be presented with a higher concentration of purge gas while the third and fourth cell 13, 14 (termed here the downstream cells) may be presented with the (compressed) gas mixture present in the assembly 8 prior to the purge operation.

Thus, the upstream cells or the cells that received the purge gas will be presented with a fuel to consume and will accordingly generate a voltage. The controllers (such as controllers 15, 16) for those cells are configured to allow a current to flow (thereby consuming the fuel) to reduce the voltage to zero indicating that the hydrogen has been consumed (and thereby removing the driving force for the current). The fuel cells may use the electrical output or a sensed voltage/fuel concentration of a different fuel cell in the assembly 8 to control their resistance. For example, a high voltage generated by upstream cells may be indicative of high fuel concentrations being received and the controllers of the downstream fuel cells may lower their resistance to ensure the fuel is consumed as it moves through the unit. In other examples, the current generated in the fuel cell assembly 8 could be utilised for powering, in full or in part, the controllers 15-18 and/or systems of the main fuel cell 2. In other examples, the controllers are passive and current will flow between the anodes and cathodes when fuel is present thereby consuming it.

The gas flow pipes that form the anode flow path between the fuel cells in the assembly 8 may be of a small diameter (forming a restriction between the fuel cells) and the hydrogen purge gas may therefore be substantially completely consumed before it diffuses into the downstream cells. Alternatively, the hydrogen may be consumed by the upstream cells to a predetermined level.

The purge valve 10 may be actuated after a predetermined time or when one or more of the controllers 15, 16, 17, 18 (or other sensor) reports a zero (or below a threshold) voltage across their associated fuel cell. The gas released to atmosphere through the purge valve 10 may therefore be inert and contain substantially no hydrogen fuel.

The purge valve 10 may be opened for a predetermined time or to allow a predetermined quantity of gas to be released. The predetermined time may be determined based on a measured pressure in the unit 1 and an expected flow rate through the purge valve 10. The purge valve may be configured to remain closed when the pressure in the unit 1 is below ambient pressure. This may act to prevent the ingestion of atmospheric air into the unit 1 through the purge valve 10.

Thus, the purge valve may be opened such that only anode flow path gases having a hydrogen concentration lower than a predetermined amount are released. The purge valve 10 may then be closed and the “higher concentration” purge gas initially received by the upstream cells may move along the series of fuel cells 11, 12, 13, 14 towards the downstream cells. The downstream cells may be configured to consume any remaining hydrogen not consumed by the upstream cells, thus leading to a substantially inert gas mixture at the downstream end of the assembly 8 for release to atmosphere when the purge valve 10 is next opened.

The cycle repeats at the next purge operation whereby purge gas will be received by the upstream fuel cells of the assembly 8 from the main fuel cell 2. This pushes processed or part processed (by the upstream cells) exhaust gas into the downstream cells. Thus, the exhaust flow reduces in hydrogen concentration as it is moved through the fuel cells of the assembly 8 in series.

It will be appreciated that the actuation of the purge valve 10 and the commencement of a purge operation may be coordinated such that the unit 1 is able to successfully consume the hydrogen in the anode exhaust flow by the time it flows from the upstream cells to the downstream cells of the fuel cell assembly 8. Further, the size and/or number of fuel cells in the fuel cell assembly 8 may be selected to operate efficiently with the purge operations of the main fuel cell 2.

The pressure in the fuel cell assembly 8 is dependent on the exhaust received from the main fuel cell, the amount of gas released through the purge valve 10 and the hydrogen being consumed by the fuel cell assembly 8. The purge valve 10 and consumption rate of the fuel cells 11, 12, 13, 14 may be controlled to maintain a pressure profile or the pressure may be used to control the controllers 15-18. The resistance presented to electrical flow by the controllers controls the rate at which hydrogen is consumed by the fuel cell.

The cathode flow path, which requires a supply of oxidant for the fuel cell to consume hydrogen supplied to the anode side may be supplied with air by any means. The air may be supplied from a cathode flow path through the main fuel cell module 2 similar to the anode flow path. Alternatively, the cathode flow path may receive a separate flow of air or be open to atmosphere.

In a further embodiment, the controllers 15, 16, 17, 18 are replaced with or supplemented with sensors to determine the voltage across their associated fuel cell. The purge valve may be configured to be actuated based on one or more readings from said sensors. For example, the purge valve may be opened when the voltage across the most downstream fuel cell 14 is substantially zero. Alternatively, actuation of the purge valve 10 may be dependent on the electrical output of one, two or more of the fuel cells of the fuel cell assembly 8.

The fuel cells of the fuel cell assembly 8 may comprise fuel cell stacks connected in gas flow series. The fuel cell assembly 8 may comprise a single fuel cell and actuation of the purge valve may be based on the voltage of the single fuel cell.

The conduit 9 may be configured to selectively connect the unit 1 and main fuel cell module 2. For example, the unit 1 may be connected on commencement of a purge operation and disconnected for at least a portion of the remaining time. Alternatively, the unit 1 may be selectively connected when the concentration of hydrogen in the exhaust leaving the main fuel cell module is in excess of a predetermined amount. The unit 1 may be selectively connectable to a plurality of main fuel cell modules, such as in turn.

FIG. 3 shows an example layout of the fuel cells in the fuel cell assembly 8. The fuel cell assembly comprises a tubular conduit 30 having a tubular support 31 extending therethrough. The individual fuel cells 11, 12, 13, 14 that form the fuel cell assembly 8 are mounted in gas flow series along the tubular support 31. The dashed lines around the tubular conduit show the separation between the individual cells along the assembly 8. The anode side 11a, 12a, 13a, 14a of the fuel cells 11, 12, 13, 14 are located on the outer surface of the tubular support 31. The cathode side 11c, 12c, 13c and 14c of the fuel cells are located on an inner surface of the tubular support 31. Accordingly the anode flow path is defined by the annular space between the conduit 30 and the support 31. The cathode flow path is defined by the tubular support 31. The cathode flow path may be a continuation the cathode exhaust conduit from the main system, but it will be appreciated that any oxidant flow would suffice. The tubular support 31 and fuel cells 11, 12, 13, 14 formed thereon separate the anode flow path from the cathode flow path 32. The purge valve 10 may be located at a terminal end of the conduit 30 adjacent the most downstream fuel cell 14. The anode and cathode flow paths (and therefore the fuel cells) may be arranged the other way around such that the anode flow path extends inward of the tubular support 31 and the cathode flow path extends outward of the tubular support. In this example, the conduit 30 may or may not be present.

FIG. 4 shows a flow chart illustrating how the unit 1 of FIGS. 1, 2, and 3 may be operated and comprises step 41 comprising applying the exhaust flow to a fuel cell assembly. Step 42 comprising electrically controlling the fuel cell assembly to consume any fuel present in the exhaust flow to produce a processed exhaust flow and step 43 comprising releasing said processed exhaust flow to atmosphere.

1. A fuel cell exhaust processing unit for consuming fuel in the exhaust flow of a main fuel cell module comprising;
a fuel cell assembly configured to receive the exhaust flow from an anode flow path of the main fuel cell module, the fuel cell assembly including a controller configured to control a flow of current between an anode and a cathode of at least one fuel cell in the fuel cell assembly to consume fuel remaining in the exhaust flow from the main fuel cell module to a predetermined level before the exhaust flow exits the unit.

2. The fuel cell exhaust processing unit according to claim 1, in which the fuel cell assembly comprises a plurality of individual fuel cells arranged in gas flow series to receive the exhaust flow from the anode flow path.

3. The fuel cell exhaust processing unit according to claim 2, in which the plurality of fuel cells are electrically unconnected to each other.

4. The fuel cell exhaust processing unit according to claim 3, in which the controller comprises a passive controller having a predetermined resistance.

5. The fuel cell exhaust processing unit according to claim 3, in which the controller is configured to control the flow of current of at least one fuel cell of the fuel cell assembly in response to a measure of the electrical output of at least one of the fuel cells of the fuel cell assembly.

6. The fuel cell exhaust processing unit according to claim 3, in which the fuel cell assembly comprises at least two fuel cells and the controller is configured to control the flow of current between the anode and cathode of a particular fuel cell of the assembly in response to a measure of the electrical output or sensed parameter of at least one other of the fuel cells of the fuel cell assembly located upstream of the particular fuel cell.

7. The fuel cell exhaust processing unit according to claim 1, in which the fuel cell exhaust processing unit includes a purge valve arranged downstream of the fuel cell assembly, the purge valve configured to control the emission of the exhaust flow from the processing unit.

8. The fuel cell exhaust processing unit according to claim 7, in which the purge valve is actuated by a purge valve controller, the purge valve controller configured to actuate the purge valve in response to a measure of the electrical output of at least one of the fuel cells of the fuel cell assembly.

9. The fuel cell exhaust processing unit according to claim 7, in which the purge valve is actuated by a purge valve controller, the purge valve controller configured to actuate the purge valve based on receipt of a purge signal indicative of a purge operation comprising the flow of a purge gas through the anode flow path of the main fuel cell assembly.

10. The fuel cell exhaust processing unit according to claim 7, in which the purge valve is actuated by a purge valve controller, the purge valve controller configured to actuate the purge valve based on a measure of the pressure of the exhaust flow.

11. The fuel cell exhaust processing unit according to claim 1, in which the fuel cell assembly is arranged in an exhaust pipe for processing the exhaust flow as it travels along said exhaust pipe.

12. The fuel cell exhaust processing unit of claim 1 wherein the main fuel cell module includes an anode flow path therethrough, and the processing unit is connected in gas flow series with the main fuel cell module to receive the exhaust flow.

13. The fuel cell exhaust processing combination as defined in claim 12, in which the fuel cell assembly is electrically unconnected to the main fuel cell module.

14. A method of processing an exhaust flow from a main fuel cell module comprising;
applying the exhaust flow to a fuel cell assembly;
electrically controlling the flow of current between an anode and a cathode of at least one fuel cell of the fuel cell assembly to consume any fuel present in the exhaust flow to produce a processed exhaust flow having a fuel content below a predetermined level; and
releasing said processed exhaust flow from the assembly.

15. The method according to claim 14, in which the method includes the step of controlling a purge valve, which releases exhaust flow from the fuel cell assembly, based on the electrical output of the fuel cell assembly.

16. The method according to claim 14, in which the exhaust flow is retained in the fuel cell assembly until any fuel in the exhaust flow is consumed to a predetermined level.

17. A computer program or computer program product comprising code for controlling an exhaust flow processing unit, the code when executed by a processor and memory configured to perform the following steps;
in response to receipt of an exhaust flow from a main fuel cell module by a fuel cell assembly, electrically control the flow of current between an anode and a cathode of at least one fuel cell of the fuel cell assembly to consume any fuel present in the exhaust flow to produce a processed exhaust flow having a fuel content below a predetermined level; and release said processed exhaust flow from the assembly.
